(19) United States
(12) Patent Application Publication
(10) Pub. No.: US 2018/0096210 A1
(43) Pub. Date: Apr. 5, 2018

(54) DRIVING AREA RECOGNITION DEVICE AND METHOD THEREOF

(71) Applicant: DENSO CORPORATION, Kariya-city (JP)

(72) Inventors: Shunsuke SUZUKI, Kariya-city (JP); Tomohiko TSURUTA, Nishio-city (JP); Naoki KAWASAKI, Nishio-city (JP)

(21) Appl. No.: 15/716,415

(22) Filed: Sep. 26, 2017

(30) Foreign Application Priority Data
Sep. 30, 2016 (JP) 2016-194591

(51) Int. Cl. G06K 9/00; G06K 9/62; G06T 7/13; G06T 7/60

(52) U.S. Cl. CPC G06K 9/00798; G06T 7/60; G06T 7/13; G06K 9/6215

(57) ABSTRACT

A driving area recognition device has an image acquiring section for acquiring image data transmitted from an in-vehicle monocular camera and an extraction section for extracting, from the acquired image data, edge points in boundary parts arranged at both the right side and the left side of a driving area of a vehicle. The device further has a setting section for setting plural provisional areas as candidates of the driving area so that at least a part of each of the plural provisional areas is overlapped together, a calculation section for calculating the number of edge points in each of the plural provisional areas, and a recognition section for recognizing the driving area based on the plural provisional areas and the number of edge points in each of the plural provisional areas.

### CROSS-REFERENCE TO RELATED APPLICATION

This application is related to and claims priority from Japanese Patent Application No. 2016-194591 filed on Sep. 30, 2016, the contents of which are hereby incorporated by reference.

### BACKGROUND OF THE INVENTION

### 1. Field of the Invention

The present invention relates to driving area recognition devices and methods capable of recognizing a driving area of an own vehicle on a driving lane of a highway on which the own vehicle drives.

### 2. Description of the Related Art

There has been known a conventional vehicle position recognition device capable of detecting variation in a lateral direction of an own vehicle deviated from a central line of a driving lane on which the own vehicle drives. For example, patent document 1, Japanese patent laid open publication No. H7-128059 discloses such a conventional vehicle position recognition device which extracts edge points from image data transmitted from an in-vehicle camera, and extracts an outline of each of white boundary lines on a driving lane of a highway on the basis of the extracted edge points. The white boundary lines are painted at the right hand side and the left hand side of the driving lane on the highway on which the own vehicle drives.

The conventional vehicle position recognition device having the structure previously described continuously calculates central points of the extracted white boundary lines, and approximates the calculated central points by using a quadratic curve, and determines the current position of the own vehicle on the driving lane on the basis of the approximated quadratic curve.

The conventional vehicle position recognition device extracts edge points from the acquired image data, and selects specific edge points so as to extract white boundary lines from the image data. That is, the conventional vehicle position recognition device selects each of the specific edge points having a brightness of not less than a predetermined brightness. However, there is a possible drawback in which the selected edge points having a brightness of not less than the predetermined brightness contain edge points which belong to other road markings other than the white boundary lines. For example, when one or more other roads including branch roads are branched at a junction from a highway in one or more different directions, the conventional vehicle position recognition device detects edge points on a white line painted on a branch road, which is different from the lane boundary line on the highway. Incorrect recognition often occurs due to the presence of such road markings, in which the conventional vehicle position recognition device causes incorrect recognition of the road markings as white boundary lines on the highway. The conventional vehicle position recognition device often causes incorrect recognition of road markings due to strong influence from incorrect edge points belonging to road markings other than white boundary lines painted on a highway, in particular, when the conventional vehicle position recognition device executes approximation of central points of outlines at both the right hand side and the left hand side of the driving lane of the own vehicle on the highway by using a quadratic curve.

When white boundary lines are present in the image data which has been transmitted from the in-vehicle camera, there is a possible case in which the white boundary lines are hidden by an obstacle (for example, other vehicles on a highway), and the conventional vehicle position recognition device detects no edge point belonging to the white boundary line. This often causes an incorrect recognition of white boundary lines, arranged at both the right hand side and the left hand side of the driving lane on which the own vehicle drives when the conventional vehicle position recognition device distinguishes the driving lane from other driving lanes on the highway.

If the conventional vehicle position recognition device cannot correctly specify the white boundary lines on the driving lane of the own vehicle and distinguishes the while boundary lines on the driving lane of the own vehicle from white boundary lanes on another driving lane on a highway, it also difficult for the conventional vehicle position recognition device to correctly recognize a driving area of the own vehicle on the driving lane.

### SUMMARY

It is therefore desired to provide a driving area recognition device and a driving area recognition method for correctly recognizing a driving area of an own vehicle on a driving lane on a highway with high accuracy.

An exemplary embodiment provides a driving area recognition device comprising a computer system including a central processing unit. The computer system is configured to provide an image acquiring section, an extraction section, a setting section, a calculation section and a recognition section. The image acquiring section receives and acquires image data captured by and transmitted from an in-vehicle camera. The extraction section extracts, from the acquired image data, edge points in boundary parts which are arranged at a right hand side and a left hand side of a driving area of an own vehicle on a driving lane on which the own vehicle drives. The setting section determines plural provisional areas to be used as candidates of the driving area of the own vehicle so that at least a part of each of the plural provisional areas is overlapped with each other. The calculation section calculates the number of edge points in each of the plural provisional areas. The recognition section recognizes the driving area of the own vehicle on the basis of the plural provisional areas and the number of edge points in each of the plural provisional areas.

When edge points are extracted from image data regarding boundary parts on the driving lane on which the own vehicle drives, the extracted edge points in the boundary parts are in general arranged in line. Accordingly, if an extraction area, from which the edge points are extracted, is slightly shifted from the boundary part, the number of edge points extracted from the extraction area is drastically reduced, and a difference in the number of edge points between the boundary part and the shifted extraction area is also drastically reduced.

Accordingly, the driving area recognition device according to the present invention determines plural provisional areas so that at least a part of each of the plural provisional areas is overlapped with each other, and recognizes the driving area on the basis of the plural provisional areas and the number of edge points in each of the plural provisional areas. Even if the driving area recognition device detects edge points which do not belong to the edge points in the boundary parts, the driving area recognition device can correctly detect the driving area of the own vehicle on the basis of the number of edge points belonging to the boundary parts arranged along the driving area of the own vehicle on the driving lane.

Further, when there is a branch road, which crosses with the roadway (highway) as a main road, and when edge points, which do not belong to the edge points extracted from the boundary parts arranged along the driving area of the own vehicle on the driving lane, are detected, it is possible for the driving area recognition device to correctly recognize the driving area of the own vehicle on the driving lane on the basis of the number of extracted edge points from the boundary parts arranged along the driving area of the own vehicle.

Still further, when a part of the edge points belonging to the driving area of the own vehicle is hidden by an obstacle and a part of the edge points belonging to the boundary parts is not detected, it is possible for the driving area recognition device to correctly recognize the driving area of the own vehicle on the driving lane on the basis of the number of extracted edge points from the boundary parts arranged along the driving area.

### BRIEF DESCRIPTION OF THE DRAWINGS

A preferred, non-limiting embodiment of the present invention will be described by way of example with reference to the accompanying drawings, in which:

FIG. 1 is a view showing a block diagram of a schematic structure of a driving area recognition device according to a first exemplary embodiment of the present invention;

FIG. 2 is a view showing a provisional area on a driving lane of an own vehicle on a highway obtained by the driving area recognition device according to the first exemplary embodiment shown in FIG. 1;

FIG. 3A to FIG. 3D are views, each schematically showing the provisional area on the driving lane of an own vehicle which are changed from each other by using different variables;

FIG. 4A and FIG. 4B are views, each schematically showing the provisional area on the driving lane of the own vehicle;

FIG. 5 is a flow chart showing a driving area recognition process executed by the driving area recognition device according to the first exemplary embodiment shown in FIG. 1;

FIG. 6 is a flow chart showing a provisional area setting process executed by the driving area recognition device according to the first exemplary embodiment shown in FIG. 1;

FIG. 7 is a flow chart showing an edge point evaluation process executed by the driving area recognition device according to the first exemplary embodiment shown in FIG. 1;

FIG. 8A to FIG. 8C are views schematically showing a driving area of the own vehicle; and

FIG. 9 is a view showing a flow chart of another driving area recognition process executed by the driving area recognition device according to a fourth exemplary embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Exemplary Embodiment

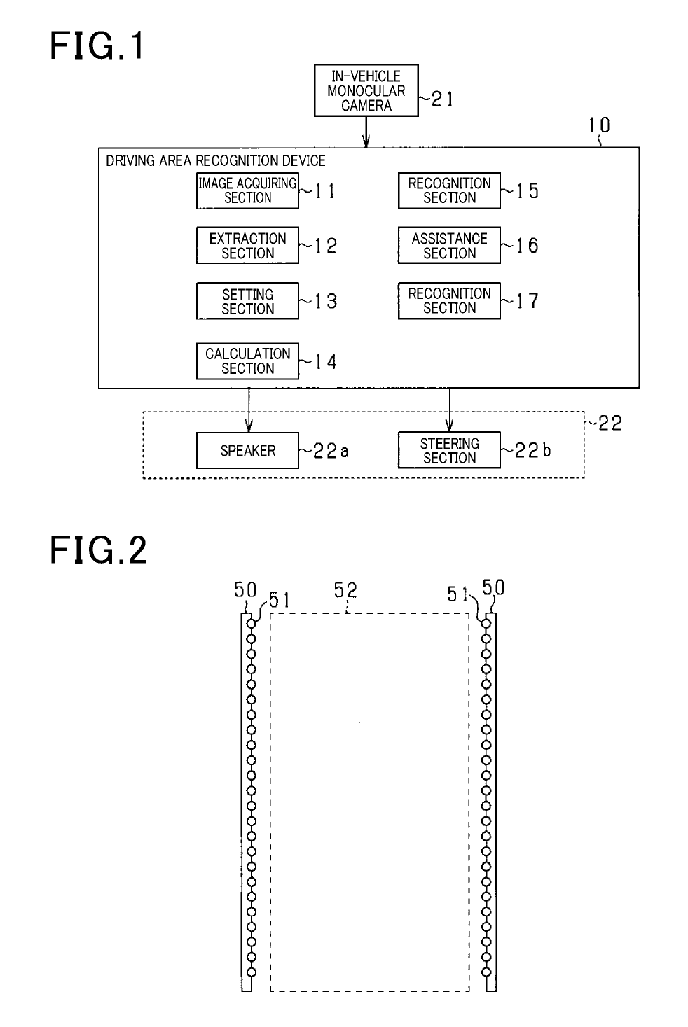

A description will be given of a driving area recognition device and a driving area recognition method according to a first exemplary embodiment with reference to FIG. 1 to FIG. 8.

FIG. 1 is a view showing a block diagram of a schematic structure of the driving area recognition device 10 according to the first exemplary embodiment.

The driving area recognition device 10 according to the first exemplary embodiment shown in FIG. 1 is mounted on an own vehicle, and detects and recognizes a driving area on a driving lane on a highway on which the own vehicle drives.

As shown in FIG. 1, the driving area recognition device 10 communicates with an in-vehicle monocular camera 21 as an in-vehicle camera mounted on the own vehicle. The in-vehicle monocular camera 21 is composed of an image pickup device such as a CCD (Charge Coupled Device), a CMOS (Complementary Metal Oxide Semiconductor). The in-vehicle monocular camera 21 is arranged on an upper side of a windshield of the own vehicle and captures front view image in front of the own vehicle. The front view image contains a front view including the driving lane on which the own vehicle drives and surround image of the own vehicle. The in-vehicle monocular camera 21 captures image data regarding the front view image and transmits the image data to the driving area recognition device 10. It is also acceptable for the own vehicle to have one or more in-vehicle cameras (to form a compound eye camera).

The driving area recognition device 10 is composed of a computer equipped with a central processing unit (CPU), a read only memory (ROM), a random access memory (RAM), an input/output interface, etc.

As shown in FIG. 10, the driving area recognition device 10 has functional blocks composed of an image acquiring section 11, an extraction section 12, a setting section 13, a calculation section 14, a recognition section 15 and an assistance section 16.

The image acquiring section 11 acquires image data captured by and transmitted from the in-vehicle monocular camera 21. The extraction section 12 extracts edge points belonging boundary parts as while boundary lines from the acquired image data. The setting section 13 determines a provisional area on the driving lane on which the own vehicle drives. The provisional area is a candidate of the driving area of the own vehicle. The calculation section 14 calculates the number of detected edge points in the provisional area. The recognition section 15 recognizes a driving area on the driving lane of the own vehicle. The assistance section 16 assists the driver's steering on a highway to keep the own vehicle in the middle of the driving lane to have a safe driving as well as in a risk avoidance maneuver in case of an emergency.

The driving area recognition device 10 further has a memory section 17 to store various programs. The driving area recognition device 10 executes the programs to execute the functions of each of the image acquiring section 11, the extraction section 12, the setting section 13, the calculation section 14, the recognition section 15 and the assistance section 16.

It is also acceptable to use hardware circuits capable of realizing the functions of each of the image acquiring section 11, the extraction section 12, the setting section 13, the calculation section 14, the recognition section 15 and the assistance section 16. It is also acceptable to realize a part of those functions by using software programs executed by the computer.

The image acquiring section 11 acquires image data captured by and transmitted from the in-vehicle monocular camera 21. That is, the image acquiring section 11 sequentially receives and acquires the image data at every predetermined period of time (for example, every 100 ms). In the driving area recognition device according to the first exemplary embodiment shown in FIG. 1, the image acquiring section 11 converts the received image data transmitted from the in-vehicle monocular camera 21 to a plan image (i.e. from the above of the own vehicle) on the basis of a height of the position of the in-vehicle monocular camera 21 measured from the road surface of the driving lane on which the own vehicle drives and an elevation angle of the in-vehicle monocular camera 21.

The following explanation will use the plane image which has been converted from the acquired image data transmitted from the in-vehicle monocular camera 21. It is also acceptable for the image acquiring section 11 to directly use the image data transmitted from the in-vehicle monocular camera 21, and further acceptable to use variable period of time for receiving the image data transmitted from the in-vehicle monocular camera 21.

FIG. 2 is a view showing a provisional area of the own vehicle on the driving lane obtained by the driving area recognition device 10 according to the first exemplary embodiment shown in FIG. 1.

As shown in FIG. 2, the extraction section 12 extracts edge points 51 in boundary parts 50 at both the right hand side and the left hand side of the own vehicle in the driving area on the driving lane on which the own vehicle drives. The boundary parts 50 represent boundaries of the driving lane on the highway on which the own vehicle drives. The boundary parts 50 include boundary lines made of road markings, road studs, road stones, etc. There are road marking paint laid on a road surface as the road markings. It is also acceptable for the boundary parts 50 to include guard rails, road walls arranged along the direction of a roadway, curb lines on a roadway, traffic structures arranged along a roadway.

The extraction section 12 extracts the edge points 51 on the basis of a variation of brightness of each of the edge points along a scanning direction in the acquired image data obtained by the image acquiring section 11. In more detail, the extraction section 12 scans the acquired image data in a right direction and a left direction around the position of the own vehicle in the acquired image data, and extracts edge points having a brightness which is not less than the predetermined brightness value. It is also acceptable for the extraction section 12 to extract edge points having a brightness of not more than the predetermined value.

It is further acceptable for the extraction section 12 to use another detection method of extracting edge points. For example, it is acceptable for the extraction section 12 to apply a Sobel filter to the acquired image data so as to extract edge points from the acquired image data. The extraction section 12 calculates a coordinate of each of the extracted edge points 51 on the acquired image data, and stores the calculated coordinate corresponding to each of the extracted edge points 51 into the memory section 17.

The setting section 13 determines plural provisional areas 52 from the acquired image data, to be used as candidates of the driving area. In general, the edge points 51 in the boundary parts 50 are arranged in line at both the right hand side and the left hand side of the own vehicle in the driving area on the driving lane. For example, as shown in FIG. 2, the edge points 51 are arranged in line along the boundary parts 50.

For this reason, when the provisional area 52 is arranged along the boundary parts 50 and the provisional area 52 is shifted toward the right hand side, for example, the number of edge points 51 in the provisional area 52 drastically reduces or increases. Accordingly, the setting section 13 prepares a plurality of the provisional areas 52 so that at least some of these provisional areas are overlapped with each other.

Specifically, the setting section 13 uses one or more variables which affect various conditions of each of the provisional areas 52. The setting section 13 determines the provisional areas 52 by changing values of the variables.

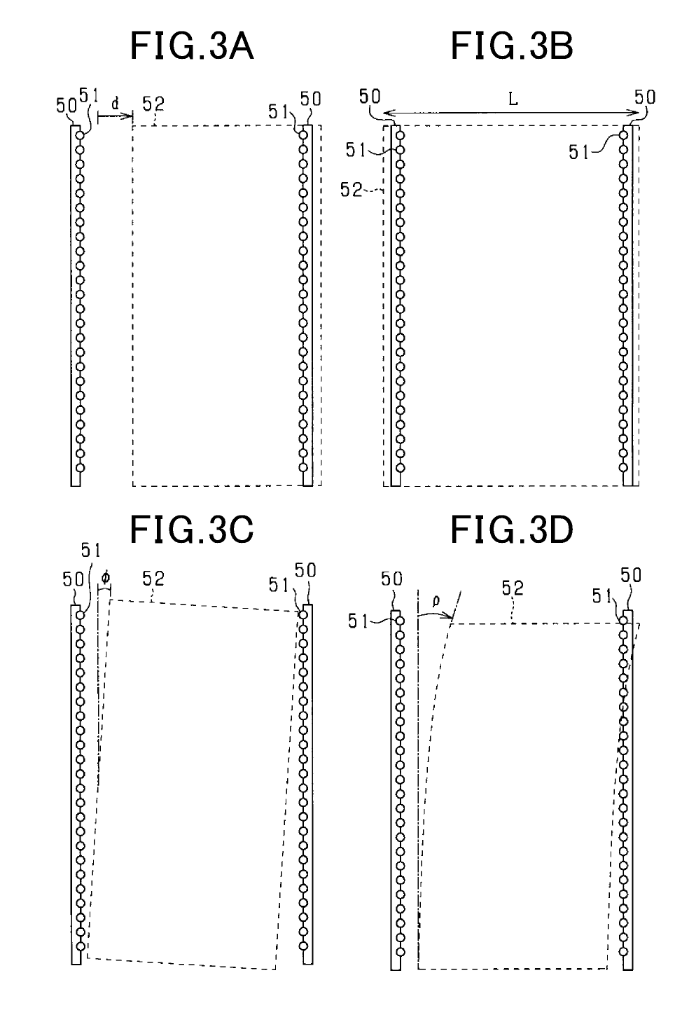

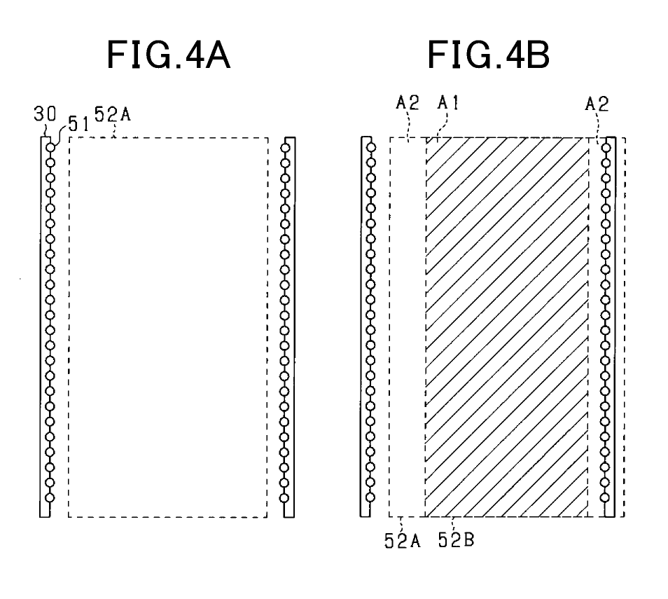

For example, there is an offset d as a variable to affect a position of the provisional area 52. The offset d represents a shifted value of the own vehicle in a width direction of the driving lane. For example, as shown in FIG. 2, when the offset value d varies in the provisional area 52, the provisional area 52 is shifted in the width direction of the driving lane as shown in FIG. 3A.

FIG. 3A to FIG. 3D are views schematically showing the provisional areas 52 on the driving lane of the own vehicle which are changed from each other by using different variables.

There is an area width L as the variables which affects a size of the provisional areas 52. The area width (see FIG. 3B) represents a distance of the provisional area 52 in the width direction of the driving lane. For example, when the setting section 13 changes the area width of the provisional area 52 shown in FIG. 2, the provisional area 52 has a new area width L shown in FIG. 3B.

Further, there is a yaw angle φ as one of the variables, which affects a direction of the provisional area 52. The yaw angle φ is a slant of the provisional area 52 to the moving direction of the own vehicle on the driving lane. For example, when the setting section 13 changes the yaw angle φ in the provisional area 52 shown in FIG. 2, the inclination of the provisional area 52 is varied by the yaw angle φ, as shown in FIG. 3C.

Still further, there is a curvature ρ as one of the variables to affect a shape of the provisional area 52. The curvature ρ represents a curvature of the provisional area 52. For example, when the setting section 13 changes a value of the curvature ρ of the provisional area 52, a square shape of the provisional area 52 shown in FIG. 2 is changed to another curved shape shown in FIG. 3D. In this case, the provisional area 52 is changed from a square shape (see FIG. 2) to a curved shape (see FIG. 3D).

The setting section 13 selects at least one of the variables, i.e. the area width L, the yaw angle φ and the curvature ρ, and the setting section 13 changes values of the selected variables, and generates plural provisional areas 52 on the basis of the variations of the selected variables.

Each of the variables has predetermined plural values which are changed stepwise. The setting section 13 uses the changed values of the selected variables so that each of at least some of these provisional areas is overlapped to each other. In more detail, the setting section 13 shifts the provisional areas stepwise by a predetermined non-overlapped area so as to change the value of each variable. For example, the offset d as one of the variables has plural values which are changed stepwise every 0.1 m intervals.

FIG. 4A and FIG. 4B are views schematically showing the provisional area on the driving lane of the own vehicle.

When the offset value d is changed stepwise by one step, the provisional area 52A on the driving lane shown in FIG. 4A is changed to the provisional area 52B shown in FIG. 4B. The provisional area 52B shown in FIG. 4B is shifted from the provisional area 52A shown in FIG. 4A by 0.1 m of the offset d.

As shown in FIG. 4B, when the offset d is changed by one step, the provisional area 52B is shifted from the provisional area 42A shown in FIG. 4A by the predetermined non-overlapped area A2. In FIG. 4B, the overlapped area A1 is designated by using slant lines.

Similar to the offset d, other variables such as the area width L, the yaw angle φ, and the curvature ρ are changed stepwise. As previously described, the variables are changed stepwise, the provisional area 52 is shifted from another provisional area by the predetermined non-overlapped area.

The driving area recognition device 10 sequentially recognizes the driving area on the driving lane, on which the own vehicle drives every predetermined period (for example, every 100 meters). Accordingly, a part of the currently recognized driving area must be overlapped with a part of the previously-recognized driving area. The setting section 13 determines, as reference values, one or more variables which have been used in the previous recognition of the driving area, and changes the value of the variables within a predetermined range around the reference values (as a central point).

The predetermined range has been determined for every variable so that a part of the provisional area must be overlapped within the predetermined range with a part of the previously-determined provisional area.

Specifically, the setting section 13 determines the predetermined range of each variable around the reference value (as the central point) so as to increase or reduce the value of each variable by the predetermined steps (two steps in the first exemplary embodiment). When the setting section 13 uses the reference value, the value of the variable is changed, i.e. increased around this reference value by one step, and the value of the variable is increased around this reference value by two steps, the value of the variable is reduced around this reference value by one step, and the value of the variable is reduced around this reference value by two steps.

For example, when the reference value of the offset d is 0.3 meters, the setting section 13 uses the values within the predetermined range. That is, the setting section 13 uses the reference value of 0.3 meters, the value of 0.4 meters which has been obtained by shifting, i.e. increasing the reference value toward the right hand side by one step, the value of 0.5 meters which has been obtained by increasing the reference value toward the right hand side by two steps, the value of 0.2 meters which has been obtained by shifting i.e. reducing the reference value toward the right hand side by one step, and the value of 0.1 meters which has been obtained by reducing the reference value toward the right hand side by two step. In other words, it can be expressed that the value of 0.2 meters has been obtained by increasing the reference value toward the left hand side by one step. Similar to the offset d, it is possible for the setting section 13 to uses the values within the predetermined range of each of the area width L, the yaw angle φ and the curvature ρ, respectively.

The setting section 13 generates the plural provisional areas 52 in the acquired image data by changing each of the variables within the predetermined range. The driving area recognition device 10 according to the first exemplary embodiment can use five values of each of the variables such as the offset d, the area width L, the yaw angle φ and the curvature ρ. Accordingly, the driving area recognition device 10 according to the first exemplary embodiment can use 625 combinations of the values of the variables (i.e. the combinations composed of the five values of the offset d, the five values of the area width L, the five values of the yaw angle φ and the five values of the curvature ρ). As a result, the setting section 13 can determine 625 provisional areas 52.

The calculation section 14 calculates the number of edge points 51 which are present in each of the plural provisional areas 52 determined by the setting section 13. The calculation section 14 stores the number of edge points 51 in each of the provisional areas 52 into the memory section 17.

As previously described, the edge points 51 in each of the boundary parts 50 are arranged in line.

In each area combination having an overlapped area of not less than a predetermined area, it can be considered that the pair of the provisional areas in each area combination having a maximum difference in the number of edge points between each area combination, i.e. each pair of the provisional areas 52 to be near to the driving area of the own vehicle on the driving lane. It can be considered that the pair of the provisional areas is arranged along the edge points 51 of the boundary parts 50 when the pair of the provisional areas has the maximum difference in the number of edge points in spite of having the overlapped area of not less than the predetermined area.

The recognition section 15 in the driving area recognition device 10 recognizes the driving area on the driving lane on the basis of the provisional areas 52 and the number of edge points in each of the provisional areas 52.

A description will now be given of more detailed explanation of the recognition of the driving executed by the recognition section 15.

The recognition section 15 generates plural pairs of the provisional areas 52 (hereinafter, each pair of the provisional areas is referred to as the “area combination”). The provisional areas in each area combination have the overlapped area which is not less than the predetermined area, and these provisional areas are overlapped with each other by the overlapped area.

The recognition section 15 in the driving area recognition device 10 according to the first exemplary embodiment uses one or two variables, and determines the plural area combinations by using different values of the variable, which are different by one step. For example, it is acceptable for the recognition section 15 to use the area combinations by using different values of the offset d by one step (for example, by using the offset d of 0.3 m and the offset d of 0.4 m), and the other variables have a constant value. It is also acceptable for the recognition section 15 to use the area combinations in which the offset d and the area width L have different values which are changed by one step, and the other variables have a constant value.

When one variable is varied by one step, the provisional area 52 is shifted by the predetermined non-contacted area. For this reason, when two provisional areas 52 as the area combination in which one of the variables is varied by one step are combined as the area combination, it is possible to obtain the pair of the provisional areas 52 as the area combination which are shifted by the predetermined non-overlapped area.

It is also acceptable for the recognition section 15 to combine two provisional areas 52 having the overlapped area of not less than a predetermined value. Further, it is acceptable for the recognition section 15 to combine two provisional areas 52 in which one of the variables has different values which are changed by one step. Further, it is acceptable for the recognition section 15 to combine two provisional areas 52 in which one or more variables have different values which are changed by one step. Still further, it is acceptable for the recognition section 15 to combine two provisional areas 52 in which one of the variables has different values which are changed by plural steps. Still further, it is acceptable for the recognition section 15 to combine two provisional areas 52 which are shifted with each other by the predetermined non-overlapped area.

The recognition section 15 calculates a difference of the number of edge points 51 (hereinafter, referred to as the “edge point difference”) between the provisional areas in each of the area combinations. That is, each area combination is composed of the two provisional areas 52. The recognition section 15 compares the calculated edge point differences so as to specify one or more area combinations having the maximum edge point difference.

The recognition section 15 further specifies the area combination having a minimum number of the edge points 51 in the area combinations having the maximum edge point difference.

When there are plural area combinations having the maximum edge point difference (when there are plural combinations of the pair of the provisional areas having the same difference in the edge points), the recognition section 15 selects and specifies the provisional areas 52 having the minimum number of the edge points 51. The recognition section 15 recognizes the specified provisional area 52 as the driving area of the own vehicle on the driving lane.

The provisional area 52 having a smaller number of the edge points 51 in the provisional areas 52 of the pair arranged along the boundary part 50 has a highly possible case in which the provisional area 52 is arranged inside of the boundary part 50, and the recognition section 15 recommends the own vehicle to drive on the provisional area 52 having to smaller number of the edge points 51. Accordingly, the determination of the provisional area 52 having a smaller number of the edge points 51 provides safe driving to the driver of the own vehicle.

When recognizing the driving area on the driving lane, the recognition section 15 stores the values of the variables, which have been used for determining the driving area of the own vehicle on the driving lane into the memory section 17. The value of the variables stored in the memory section 17 will be used as the reference values by the next recognition process of determining the driving area on the driving lane.

The assistance section 16 executes driving assistance of the own vehicle on the basis of the driving area recognized by the recognition section 15. Specifically, the assistance section 16 instructs an assistance execution device 22 to execute the driving assistance on the basis of the recognized driving area of the own vehicle on the driving lane. For example, the driving area recognition device 10 is connected to a speaker 22a which may act as a function of the assistance execution device 22. The assistance section 16 instructs the speaker 22a to output warning sound to the driver of the own vehicle when the own vehicle deviates from the driving area on the driving lane.

Further, when the driving area recognition device 10 is connected to the steering section 22b as the assistance execution device 22. The steering section 22b is a device for adjusting the moving direction of the own vehicle. For example, the assistance section 16 instructs the steering section 22b so as to move the own vehicle toward the central part on the driving area on the driving lane.

When a distance between the own vehicle and the boundary line 50 (i.e. the distance measured from the own vehicle to a boundary of the driving lane in a width direction of the driving lane) is not more than a predetermined distance, it is acceptable for the assistance section 16 to execute the driving assistance process.

Further, when an angle of inclination between a central line on the driving area and the moving direction of the own vehicle on the driving area is not less than a predetermined angle, it is acceptable for the assistance section 16 to execute the driving assistance process.

In the driving area recognition device 10 according to the first exemplary embodiment, the driving area recognition device 10 has the assistance section 16. The concept of the present invention is not limited by the structure of the first exemplary embodiment. It is acceptable to use another device having the assistance section 16 in addition to the driving area recognition device 10. In this structure, the device having the assistance section 16 is connected to the assistance execution device 22, the assistance section 16 receives the driving area recognized by and transmitted from the driving area recognition device 10. The assistance section 16 executes the driving assistance process on the basis of the received driving area transmitted from the driving area recognition device 10.

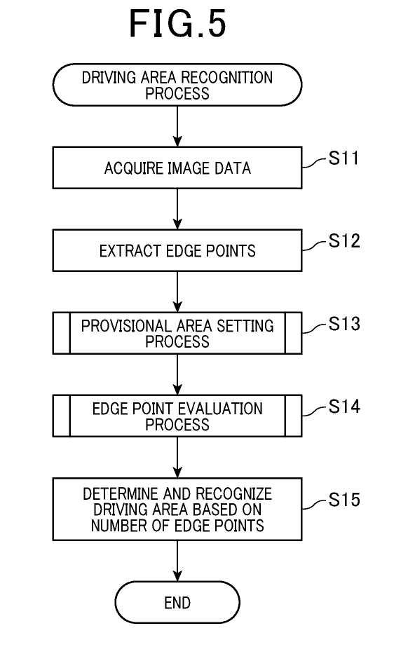

A description will be given of the driving area recognition process with reference to FIG. 5 to FIG. 7.

FIG. 5 is a flow chart showing the driving area recognition process executed by the driving area recognition device 10 according to the first exemplary embodiment shown in FIG. 1.

In step S11 shown in FIG. 5, the driving area recognition device 10 periodically executes the driving area recognition process shown in FIG. 5 at every period of time of 100 milliseconds. When the driving area recognition device 10 executes the driving area recognition process, the driving area recognition device 10 acquires image data captured by and transmitted from the in-vehicle monocular camera 21. The operation flow progresses to step S12.

In step S12, the driving area recognition device 10 extracts, from the acquired image data, edge points in the boundary parts 50 arranged at the right hand side and the left hand side in the driving area of the own vehicle on the driving lane. The operation flow progresses to step S13.

In step S13, the driving area recognition device 10 executes a provisional area setting process so as to determine the plural provisional areas 52 which are as plural candidates of the driving area of the own vehicle. This provisional area setting process will be explained in detail later. The operation flow progresses to step S14.

In step S14, the driving area recognition device 10 executes an edge point evaluation process so as to specify one of the provisional areas 52 on the basis of the number of edge points extracted from the provisional areas 52. The selected provisional area 52 is suitable for the driving area of the own vehicle. This edge point evaluation process will be explained in detail later. The operation flow progresses to step S15.

In step S15, the driving area recognition device 10 recognizes, as the driving area of the own vehicle, the provisional area 52 specified in step S14.

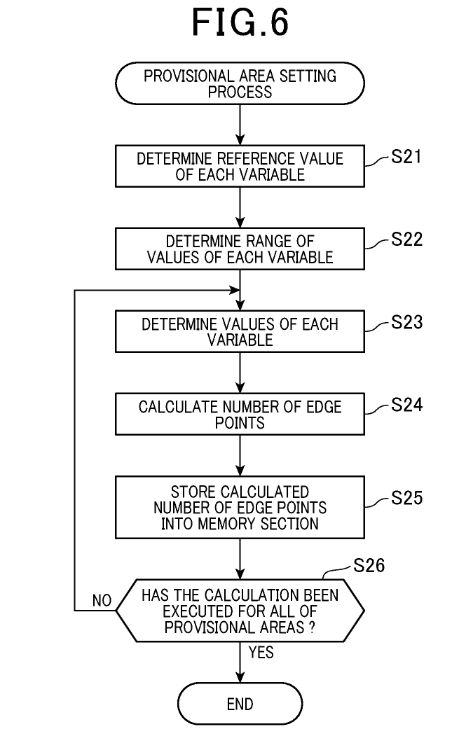

A description will now be given of the provisional area setting process executed in step S13 with reference to FIG. 6.

FIG. 6 is a flow chart showing the provisional area setting process executed by the driving area recognition device 10 according to the first exemplary embodiment shown in FIG. 1.

In step S21, the driving area recognition device 10 determines the reference values of each of the variables on the basis of the values of each variable used in the previous driving area recognition process (i.e. the provisional area 52 previously recognized as the driving area). The operation flow progresses to step S22.

In step S22 shown in FIG. 6, the driving area recognition device 10 determines a range of each variable. In step S22, the driving area recognition device 10 determines to change each variable every by two steps around the reference value. The operation flow progresses to step S23.

In step S23, the driving area recognition device 10 determines the values of each variable within the determined range thereof, and determines the provisional areas 52. The operation flow progresses to step S24.

In step S24, the driving area recognition device 10 calculates the number of edge points 51 in each of the provisional areas 52 (which are detectable areas from the acquired image data) determined in step S23. The operation flow progresses to step S25.

In step S25, the driving area recognition device 10 stores the number of edge points 51 in each of the provisional areas 52 into the memory section 17. The operation flow progresses to step S26.

In step S26, the driving area recognition device 10 detects whether the number of edge points 51 has been calculated in each of the provisional areas 52 by changing the value of each variable within the predetermined range. That is, the driving area recognition device 10 judges whether all of the combinations of the values of each variable have been used for calculating the number of edge points in each of the provisional area 52.

When the driving area recognition device 10 has calculated the number of edge points 51 in each of the provisional areas 52 as the detectable provisional areas (“YES” in step S26), the driving area recognition device 10 finishes the execution of the provisional area setting process.

On the other hand, when the driving area recognition device 10 has not yet calculated the number of edge points 51 in each of the provisional areas 52 as the detectable provisional areas (“NO” in step S26), the operation flow progresses to step S23. In step S23, the driving area recognition device 10 specifies a new value of one or more variables within the range of each variable determined in step S22 while avoiding the same area combination from being selected. That is, the driving area recognition device 10 determines the new values of each variable so as to select the provisional areas 52 which have not been determined previously.

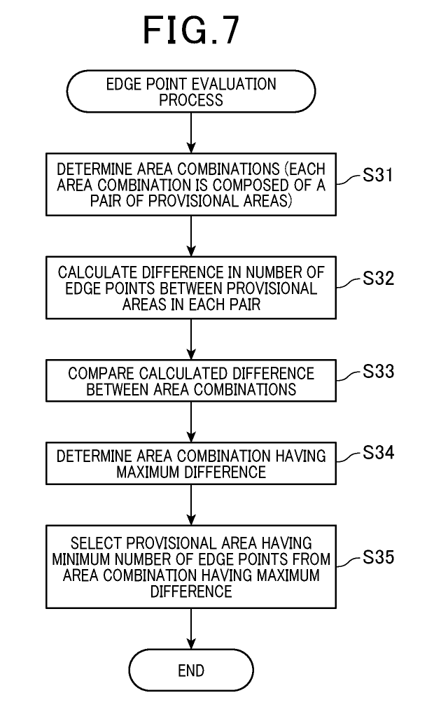

A description will now been given of the edge point evaluation process in step S14 shown in FIG. 5 with reference to FIG. 7.

FIG. 7 is a flow chart showing the edge point evaluation process executed by the driving area recognition device 10 according to the first exemplary embodiment shown in FIG. 1.

In step S31, the driving area recognition device 10 determines plural area combinations, each of which is composed of a pair of the provisional areas 52 having the overlapped area of not less than the predetermined area. The operation flow progresses to step S32.

In step S32, the driving area recognition device 10 calculates a difference in the number of edge points 51 between the two provisional areas in each pair of the provisional areas 52 having the overlapped area of not less than the predetermined area. After the calculation of the difference of the number of edge points, the operation flow progresses to step S33.

In step S33, the driving area recognition device 10 compares the calculated differences with each other. The operation flow progresses to step S34.

In step S34, the driving area recognition device 10 determines and specifies the area combination composed of the pair of the provisional areas having the maximum difference regarding the number of edge points. The operation flow progresses to step S35.

In step S35, the driving area recognition device 10 specifies the provisional area 52 having the minimum number of the edge points 51 from the area combinations (each of which is composed of the pair of the provisional areas) having the maximum difference regarding the number of edge points. The driving area recognition device 10 determines, and specifies the selected provisional area 52 having the minimum number of the edge points 51.

When there are plural area combinations having the maximum difference of the number of edge points, the driving area recognition device 10 specifies the provisional area 52 having the minimum number of the edge points from these plural area combinations.

It is also acceptable for the driving area recognition device 10 to select and specify the provisional area 52 having the maximum overlapped area with the previously recognized driving area, instead of executing step S35 or together with the execution of step S35. After this process, the driving area recognition device 10 finishes the edge point evaluation process.

After the edge point evaluation process in step S14 shown in FIG. 5 and shown in FIG. 7, the operation flow progress to step S15.

In step S15, the driving area recognition device 10 recognizes, as the driving area of the own vehicle on the driving lane, the provisional area 52 specified in step S35.

After the process of recognizing the driving area of the own vehicle on the driving lane, the driving area recognition device 10 executes the driving assistance on the basis of a relationship between the recognized driving area and the position of the own vehicle on the driving lane.

As previously described, the driving area recognition device 10 executes the driving area recognition process previously described as the driving area recognition method.

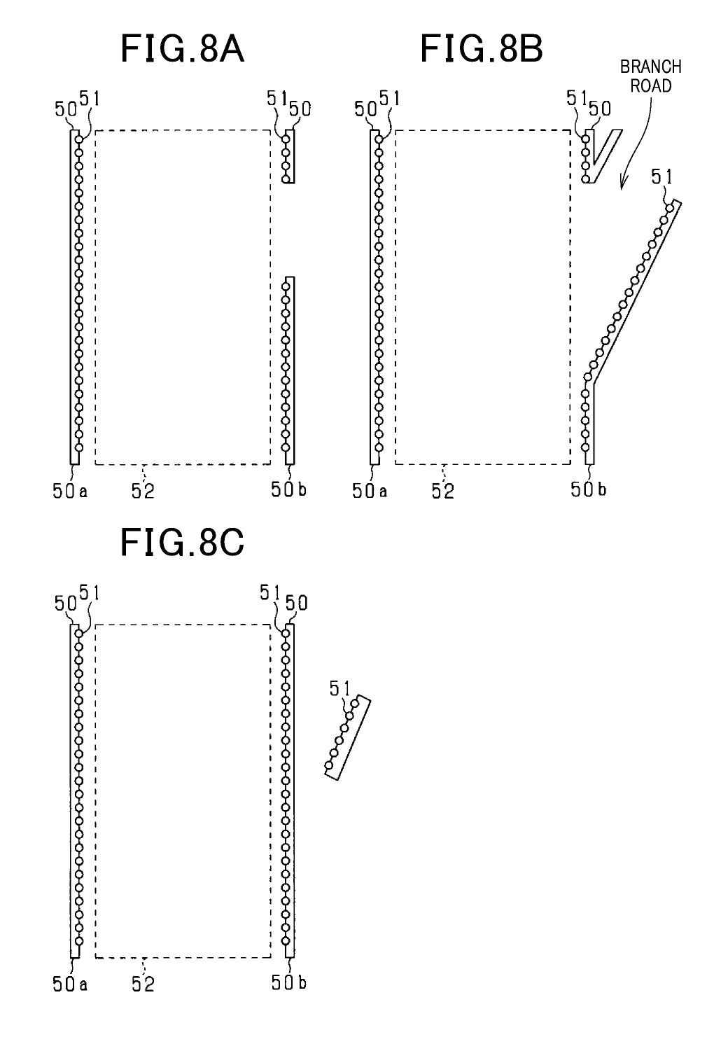

A description will be given of the explanation of the determination of the driving area with reference to FIG. 8A, FIG. 8B and FIG. 8C.

FIG. 8A, FIG. 8B and FIG. 8C are views schematically showing the driving area of the own vehicle on the driving lane.

FIG. 8A shows a case in which a part of a boundary part 50b located at a right hand side on the driving lane is interrupted. In FIG. 8A, although it is difficult to extract edge points from the interrupted area of the boundary part 50b on the driving lane, it is possible to extract edge points from the remaining part (other than the interrupted area) in the boundary part 50b in addition to a boundary part 50a located at the left hand side on the driving lane. Accordingly, it is possible for the driving area recognition device 10 to correctly recognize, as the driving area, the provisional area 52 arranged in a straight forward direction on the driving lane along the edge points 51 in the boundary parts 50a, 50b.

On the other hand, as shown in FIG. 8B, because the driving lane has a branch road, which is branched from the driving lane as a main road, the driving area recognition device 10 extracts additional edge points 51 from the branch road in addition to the edge points 51 from the boundary part 50a at the right hand side on the driving lane.

In the case shown in FIG. 8B, most of extracted edge points 51 are arranged in line. In particular, the edge points 51 arranged from the boundary part 50a located at the left hand side of the driving lane (see the left hand side in FIG. 8B) are arranged in line. The boundary part 50a is located opposite from, in the width direction of the driving lane, the boundary part 50b arranged at the right hand side from which the branch road runs toward a right obliquely upward direction.

A difference in the number of edge points between the two provisional areas 52 (not shown) along the edge points 51 becomes the maximum difference. Accordingly, it is possible for the driving area recognition device 10 to correctly recognize, as the driving area, the provisional area 52 arranged along the extracted edge points 51 in the boundary parts 50a, 50b which are arranged in a straight forward direction on the driving lane.

FIG. 8C shows edge points 51 arranged along the boundary parts 50a, 50b, and further shows edge points 51 which are arranged in a right obliquely upward direction and separated from the boundary part 50b located at the right hand side on the driving lane.

In the case shown in FIG. 8C, most of the extracted edge points 51 are arranged in a straight line, and the pair of the provisional areas 52 (not shown) arranged along most of the extracted edge points 51 have the maximum difference in the number of edge points. Accordingly, it is possible for the driving area recognition device 10 to correctly recognize, as the driving area, the provisional area 52 arranged along the direction of the extracted edge points 51 in the boundary parts 50a, 50b which are arranged in a straight forward direction on the driving lane.

According to the first exemplary embodiment previously described, it is possible for the driving area recognition device 10 to have following excellent effects.

The driving area recognition device 10 determines plural provisional areas 52 so that at least a part of each provisional area in an area combination composed of a pair of the provisional areas 52 is overlapped with each other. The driving area recognition device 10 recognizes the driving area of the own vehicle on the driving lane on the basis of the plural provisional areas 52 and the number of edge points 51 present in each of the provisional areas 52.

Accordingly, even if the driving area recognition device 10 detects edge points which do not belong to the edge points extracted from the boundary parts 50, it is possible for the driving area recognition device 10 to correctly detect the driving area on the basis of the number of edge points belonging to the boundary parts 50 arranged along the driving area of the own vehicle on the driving lane.

Further, in a case in which the driving lane has a branch road, the branch road has edge points which do not belong to the boundary parts 50 on the driving lane (as a main road) along the driving area in the driving lane, when the edge points belonging to the branch road are detected, it is possible for the driving area recognition device 10 to correctly recognize the driving area of the own vehicle on the basis of the number of extracted edge points 51 from the boundary parts 50 arranged along the driving area.

Still further, when a part of the edge points 51 belonging to the driving area is hidden by an obstacle and a part of the edge points 51 belonging to the boundary parts 50 is not detected, it is possible for the driving area recognition device 10 to correctly recognize the driving area on the driving lane on the basis of the number of extracted edge points 51 in the boundary parts 50 arranged along the driving area.

When the edge points 51 belonging to the boundary parts 50 on the driving lane are extracted, the extracted edge points 51 are concentrated and arranged in line. Accordingly, in an area combination in which a pair of the provisional areas 52 is overlapped with each other by the overlapped area of not less than the predetermined area, it can be considered that the two provisional areas 52 of the pair having the maximum difference regarding the number of edge points between the two provisional areas of the pair is most close to the driving area of the own vehicle on the driving lane. When the difference in the number of edge points between the two provisional areas 52 has the maximum value, it can be considered that these two provisional areas of the pair are arranged along the edge points in the boundary parts 50.

Accordingly, the driving area recognition device 10 compares the calculated difference of the edge points between each pair of the provisional areas, and determines, as the driving area, the provisional areas 52 having the calculated maximum difference. This makes it possible to correctly recognize the driving area of the own vehicle on the driving lane.

Further, the driving area recognition device 10 determines and uses plural area combinations, each area combination is compose of a pair of two provisional areas 52 obtained by changing one or more variables by one step. It is possible for the driving area recognition device 10 to determine and use each area combination. Each pair is composed of the two provisional areas which are shifted with each other by the non-overlapped area obtained by changing one or more variables by one step. Because, the driving area recognition device 10 compares the difference in the number of edge points between the plural area combinations, it is possible for the driving area recognition device 10 to specify the area combination having the maximum difference of the edge points in the predetermined non-overlapped area. The driving area recognition device 10 correctly recognizes the driving area of the own vehicle on the driving lane on the basis of the provisional areas 52 in the area combination having the maximum difference of the edge points.

Further, the driving area recognition device 10 determines and uses the plural provisional areas 52 by using the variables, i.e. the offset d, the area width L, the yaw angle φ and the curvature ρ. The offset d represents a shifted value of the own vehicle in the width direction of the driving lane, and affects a position of the provisional area 52.

That is, the area width L represents a distance of the provisional area 52 in the width direction of the driving lane, and affects a size of the provisional area 52. The yaw angle φ represents an inclination of the provisional area 52 to the moving direction of the own vehicle on the driving lane, and affects a direction of the provisional area 52. The curvature ρ represents a curvature of the provisional area 52, and affects a shape of the provisional area 52.

Accordingly, it is possible for the driving area recognition device 10 to determine and use the provisional area 52 which is similar to an actual driving area on the driving lane. That is, because the provisional areas 52 are determined on the basis of these variables, it is possible for the driving area recognition device 10 to avoid using a provisional area which is not similar to and is completely different from the actual driving area.

Because the driving area recognition device 10 repeatedly recognizes and uses the driving areas every predetermined period, it is possible to eliminate a provisional area which is not similar to the previously determined provisional area. For this reason, the driving area recognition device 10 uses, as the reference values, one or more variables which have been previously used in the previous recognition process, and determines new variables by changing the previously-used variables within the predetermined range from the reference values. This makes it possible to correctly determine and use the provisional areas 52, which are similar to the actual driving area on the driving lane with less error, even if the number of variables is small.

### Second Exemplary Embodiment

A description will be given of the driving area recognition device 10 according to the second exemplary embodiment.

The setting section 13 and the provisional area setting process in the driving area recognition device according to the second exemplary embodiment are different from those of the driving area recognition device according to the first exemplary embodiment. The remaining components and functions of the driving area recognition device according to the second exemplary embodiment are the same as those of the driving area recognition device according to the first exemplary embodiment. The explanation of the same components and functions of the driving area recognition devices of the first and second exemplary embodiments is omitted here.

The driving area recognition device 10 according to the second exemplary embodiment is connected to a yaw rate sensor (not shown) as a vehicle behavior detection device for detecting behavior of the own vehicle on the driving lane, i.e. for acquiring behavior information of the own vehicle. The yaw rate sensor detects an angular velocity (i.e. a yaw rate or a yaw velocity) of a rotation of the own vehicle, i.e. in a turning direction of the own vehicle. The driving area recognition device 10 can specify the moving direction of the own vehicle as the behavior of the own vehicle on the basis of the angular velocity of the own vehicle. The driving area recognition device 10 performs the function of a behavior information acquiring section for receiving a detection signal regarding the angular velocity of the own vehicle transmitted from the yaw rate sensor.

In the driving area recognition device 10 according to the second exemplary embodiment, the setting section 13 changes a value of each variable on the basis of the acquired behavior information of the own vehicle. In more detail, the setting section 13 receives the angular velocity as the behavior information of the own vehicle transmitted from the yaw rate sensor, and determines the moving direction (or the forward direction) of the own vehicle on the basis of the received angular velocity of the own vehicle. Further, the setting section 13 adjusts the range of each variable to be usable on the basis of the moving direction of the own vehicle, and determines values of each variable.

That is, the moving direction of the own vehicle specified on the basis of the detected angular velocity of the own vehicle affects the position of the driving area or the direction of the driving area. Accordingly, the setting section 13 limits the allowable range of the offset d and an allowable range of the yaw angle φ on the basis of the moving direction of the own vehicle. Specifically, when the moving direction of the own vehicle is changed toward the right hand side from the straight direction on the driving lane, the setting section 13 changes the allowable range of the offset d and the allowable range of the yaw angle toward the left hand side only. That is, when the own vehicle has moved rightward, the driving area is shifted toward the right hand side, or there is a high probability for the driving area to be shifted toward the left hand side, observed from the position of the own vehicle. Accordingly, the setting section 13 limits the range of each variable toward the left hand side.

For example, when the reference value of the offset d is 0.3 m, the setting section 13 uses the reference values of 0.3 m, the value of the offset d of 0.2 m, and the value of the offset d of 0.1 m. The value of the offset d of 0.2 m is obtained by reducing the reference value of the offset d of 0.2 m toward the right hand side by one step. The value of the offset d of 0.1 m is obtained by reducing the reference value of the offset d of 0.2 m toward the right hand side by two steps.

In a case in which the moving direction of the own vehicle is forward, i.e. in a straight line along the driving lane, the allowable offset d and the allowable yaw angle φ are obtained by shifting the reference value by one step.

For example, when the reference value of the offset d is 0.3 m, the setting section 13 uses the reference value of the offset d of 0.3 m, the value of the offset d of 0.4 m, and the value of the offset d of 0.2 m.

The value of the offset d of 0.4 m is obtained by increasing the reference value of the offset d of 0.3 m toward the right hand side by one step. The value of the offset d of 0.2 m is obtained by reducing the reference value of the offset d of 0.3 m toward the right hand side by two steps.

The setting section 13 in the driving area recognition device 10 according to the second exemplary embodiment changes each variable stepwise within the limited range thereof so as to determine plural provisional areas 52 in the acquired image data.

In the structure of the driving area recognition device 10 according to the second exemplary embodiment previously described, when receiving the angular velocity transmitted from the yaw arte sensor (not shown), the setting section 32 generates 225 provisional areas (=three values of the offset d×five values of the area width L×three values of the yaw angle φ×five values of the curvature ρ). Accordingly, the setting section 13 determines and uses 225 provisional areas 52.

In the structure of the driving area recognition device according to the second exemplary embodiment, it is acceptable to change the allowable range of each variable on the basis of a magnitude of the angular velocity. For example, when the own vehicle moves in a straight direction, it is acceptable for the setting section 13 to only use the reference value of the offset d and the reference value of the yaw angle φ.

Further, if the angular velocity is more than a predetermined value, it is acceptable for the setting section 13 to change the reference value of the offset d by two steps and the reference value of the yaw angle φ by two steps, and to use the changed values of the offset d and the changed value of the yaw angle φ only. This makes it possible to limit the range of each variable, and to reduce the number of provisional areas 52.

A description will now be given of the provisional area setting process executed by the driving area recognition device 10 according to the second exemplary embodiment with reference to FIG. 6.

When receiving the angular velocity as the behavior information of the own vehicle, the driving area recognition device 10 detects the moving direction of the own vehicle on the basis of the acquired angular velocity in step S22 shown in FIG. 6.

The driving area recognition device 10 limits the allowable range is of each variable and determines values of each variable on the basis of the moving direction of the own vehicle.

The driving area recognition device 10 determines the values of the variables within the determined allowable range thereof obtained in step S23. The driving area recognition device 10 further determines the provisional areas 52 on the basis of the values of the variables within the determined allowable range thereof.

As previously described, the driving area recognition device 10 according to the second exemplary embodiment has a following additional effect in addition to the effects obtained by the driving area recognition device 10 according to the first exemplary embodiment.

It is possible for the setting section 13 to determine the provisional areas 52 which are close to the actual driving area of the own vehicle on the driving lane by changing one or more variables on the basis of the behavior information of the own vehicle. This makes it possible to reduce the number of detection errors, and to determine the driving area of the own vehicle with high accuracy. Further, this makes it possible to reduce the total number of the provisional areas 52 and to reduce the processing load of the driving area recognition device 10.

### Third Exemplary Embodiment

A description will be given of the driving area recognition device 10 according to the third exemplary embodiment.

The calculation section 14 and the provisional area setting process in the driving area recognition device according to the third exemplary embodiment are different from those of the driving area recognition device according to the first exemplary embodiment. The remaining components and functions of the driving area recognition device according to the third exemplary embodiment are the same as those of the driving area recognition device according to the first exemplary embodiment. The explanation of the same components and functions of the driving area recognition devices of the third and first exemplary embodiments is omitted here.

It is adjusted so that a brightness level of each edge point 51 extracted from the boundary section 50 is within the predetermined allowable range. In more detail, the brightness level of the edge point 51 represents an amount of change of brightness (i.e. a gradient of brightness) of the edge point. The larger the amount of change of brightness of the edge point 51, the higher the brightness level of the edge point 51 is. For example, a brightness level of the edge points 51 on a boundary part between the surface of the driving lane and a white road marking paint is approximately constant. Accordingly, it is possible for the driving area recognition device 10 to correctly detect the edge points 52 on the boundary parts 50 with high accuracy.

The calculation section 14 in the driving area recognition device 10 according to the third exemplary embodiment corrects the number of edge points in each of the provisional areas 52 on the basis of the brightness level of each edge point 51 in each of the provisional area 52.

Specifically, the calculation section 14 counts and adjusts the number of edge points in each provisional area by eliminating the edge point having a brightness level which is out from a predetermined allowable range of brightness. This predetermined allowable range of brightness is obtained on the basis of the brightness of the edge points extracted from the boundary parts on the driving lane. For example, the calculation section 14 calculates the number of edge points which are present in each provisional area 52, from which edge points having a brightness of not within the predetermined allowable range of brightness are eliminated.

It is also acceptable for the calculation section 14 to multiply the number of edge points with a coefficient which corresponds to a brightness level of the edge point. For example, it is acceptable to multiply the number of edge points having a brightness which is not within the predetermined allowable range of brightness with a coefficient (for example, 0.5) which is smaller than 1. In this case, it is acceptable to reduce the coefficient on the basis of a difference of brightness of the edge point from the predetermined allowable range of brightness.

On the other hand, it is also acceptable to multiply the number of edge points having a brightness within the predetermined allowable range of brightness with a coefficient which is greater than 1. That is, it is acceptable to weight the number of edge points 51 due to the brightness level of each edge point 51.

A description will now be given of the provisional area setting process executed by the driving area recognition device 10 according to the third exemplary embodiment with reference to FIG. 6.

In step S24 shown in FIG. 6, the driving area recognition device 10 corrects the number of edge points 51 in the provisional areas 52 while eliminating the edge points having a brightness which is our from the predetermined allowable range of brightness.

It is acceptable for the calculation section 14 to correct the number of edge points 51 in the provisional areas 52 on the basis of the brightness level of the edge points in the provisional areas 52, similar to the calculation section 14 in the driving area recognition device 10 according to the second exemplary embodiment.

As previously described, the driving area recognition device 10 according to the third exemplary embodiment has a following additional effect in addition to the effects obtained by the driving area recognition device 10 according to the first and second exemplary embodiments.

It is possible for the driving area recognition device 10 according to the third exemplary embodiment to correctly calculate the number of edge points belonging to the boundary parts 50 with high accuracy on the basis of the brightness level of each of the extracted edge points 51. This makes it possible for the driving area recognition device 10 to correctly recognize the driving area of the own vehicle on the driving lane while reducing the calculation error.

### Fourth Exemplary Embodiment

A description will be given of the driving area recognition device 10 according to the fourth exemplary embodiment.

The driving area recognition device according to the fourth exemplary embodiment has a boundary part specifying section capable of specifying the boundary parts 50. The recognition section 15 recognizes the driving area of the own vehicle on the basis of the boundary parts 50 specified by the boundary part specifying section.

The remaining components and functions of the driving area recognition device according to the fourth exemplary embodiment are the same as those of the driving area recognition device according to the first exemplary embodiment. The explanation of the same components and functions of the driving area recognition devices of the fourth exemplary embodiment and the first exemplary embodiment is omitted here.

The driving area recognition device 10 performs the function of the boundary part specifying section so as to specify the boundary parts 50 on the driving lane on which the own vehicle drives. That is, the boundary part specifying section specifies the boundary parts 50 on the basis of the edge points 51 extracted from the acquired image data by the extraction section. Specifically, when the extracted edge points 51 are arranged in line, i.e. when the extracted edge points 51 are approximately arranged in a straight line, the boundary part specifying section determines and specifies the arrangement of the extracted edge points showing the boundary part 50. When the extracted edge points 51 are arranged within a predetermined width range measured in the width direction of the driving lane, the driving area recognition device 10 can determine that the arrangement of the extracted edge points 51 shows the boundary part on the driving lane. For example, the predetermined width range represents an allowable range of 15 cm to 30 cm.

It is also acceptable for the boundary part specifying section to use another boundary part specifying method. For example, in a case in which when the extracted edge points 51 are arranged in line at both the right hand side and the left hand side along the direction of the driving lane, and when a width between the extracted edge points 51 arranged at both the right hand side and the left hand side is constant (i.e. those edge points 51 are arranged in parallel), it is acceptable for the boundary part specifying section to determine the presence of the boundary parts 50 arranged along the extracted edge points on the driving lane. Further, it is also acceptable for the boundary part specifying section to specify a line which has been approximated by using a quadratic curve.

A description will now be given of the explanation of the setting section 13 and the recognition section 15 in the driving area recognition device 10 according to the fourth exemplary embodiment.

When the boundary part specifying section has specified the boundary parts 50 arranged at both the right hand side and the left hand side on the driving lane, the setting section 13 determines the provisional areas 52 to be used as the candidates of the driving area of the own vehicle on the basis of the specified boundary part 50. Specifically, the setting section 13 determines each variable so as to have a maximum area surrounded by the specified boundary parts 50 and determines the provisional areas 52 on the basis of the each variable.

The recognition section 15 compares the determined provisional area with the previously-recognized driving area of the own vehicle, and detects whether a difference between the determined provisional area and the previously-recognized driving area is not less than a predetermined threshold value (i.e. detects whether a non-overlapped areas between them is not less than a predetermined area). Because the driving area is recognized every period, there is a less probability that this difference between the determined provisional area and the previously-recognized driving area is not less than the predetermined threshold value. Accordingly, when this difference between the determined provisional area and the previously-recognized driving area exceeds the predetermined threshold value (i.e. when the overlapped-area exceeds a predetermined area), the recognition section 15 determines and recognizes, as the driving area, the provisional area 52 obtained on the basis of the boundary parts 52 specified by the boundary part specifying section

On the other hand, when the difference between the determined provisional area and the previously-recognized driving area is not less than the predetermined threshold value, the recognition section 15 prepares plural provisional areas 52, and determines and recognizes the driving area on the basis of the plural provisional areas 52 and the number of edge points 51 in the plural provisional areas 52. It is also acceptable for the recognition section 15 to determine and recognize the driving area on the basis of the plural provisional areas 52 and the number of edge points 51 in the plural provisional areas 52 according to an extraction state of the extracted edge points 51.

For example, when the extracted edge points 51 are not arranged in a straight line, or when plural boundary parts 50 are detected on the basis of the edge points 51 arranged in a straight line, it is acceptable for the recognition section 15 to determine and recognize the driving area on the basis of the plural provisional areas and the number of edge points in the plural provisional areas. In this case, there is a high probability in which a detection error of the driving area increases on the basis of the driving area specified by using the boundary parts 50 specified by the boundary part specifying section. In order to avoid this, it is possible for the recognition section 15 to determine and correctly recognize the driving area on the basis of the plural provisional areas 52 and the number of edge points 51 in the plural provisional areas 52 while reducing the detection error of the driving area.

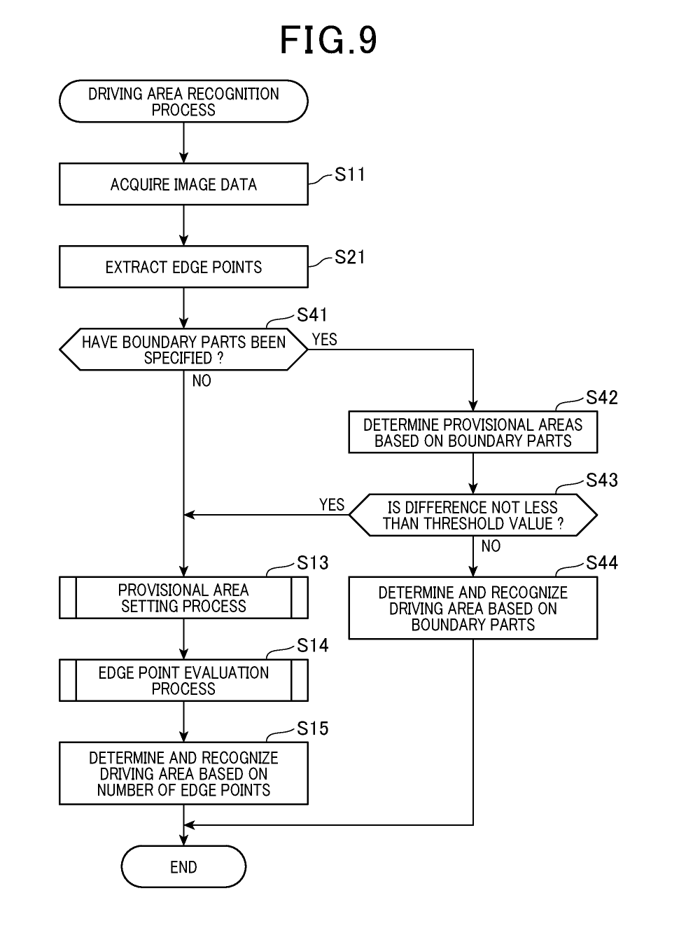

A description will now be given of the driving area recognition process executed by the recognition section 15 in the driving area recognition device 10 according to the fourth exemplary embodiment with reference to FIG. 9.

FIG. 9 is a view showing a flow chart of another driving area recognition process executed by the driving area recognition device according to the fourth exemplary embodiment.

The driving area recognition device 10 periodically executes the driving area recognition process shown in FIG. 9 at every predetermined period.

When executing the driving area recognition process, the driving area recognition device 10 acquires the image data transmitted from the in-vehicle monocular camera 21. The operation flow progresses to step S12.

In step S12, the driving area recognition device 10 extracts, from the acquired image data, edge points in the boundary parts 50 arranged at the right hand side and the left hand side in the driving area of the own vehicle on the driving lane. The operation flow progresses to step S41.

In step S41, the driving area recognition device 10 detects whether the boundary parts 50 arranged at the right hand side and the left hand side are specified on the basis of the extracted edge points 51.

When the detection result in step S41 indicates negation (“NO” in step S41), i.e. represents that the boundary parts 50 are not detected at both the right hand side and the left hand side, the operation flow progresses to step S13.

The driving area recognition device 10 detects whether the boundary parts 50 arranged at the right hand side and the left hand side have been detected on the basis of the extraction state of the edge points 51. For example, when it is detected that the extracted edge points are not arranged in line, or when plural boundary parts 50 are specified on the basis of the extracted edge points 51 arranged in line, the driving area recognition device 10 determines that it is difficult to specify any boundary part 50. The case in which the extracted edge points 51 are not arranged in line shows that the edge points of less than the predetermined brightness level are not present within the predetermined range along a line, or shows than the edge points 51 of not less than the predetermined brightness level are not present within the predetermined range in the width direction of the line.

On the other hand, when the detection result in step S41 indicates affirmation (“YES” in step S41), i.e. represents that the boundary parts 50 are detected and specified at both the right hand side and the left hand side, the operation flow progresses to step S42.

In step S42, the driving area recognition device 10 determines and specifies the boundary parts 50 at both the right hand side and the left hand side, and determines the provisional areas 52 as the candidates of the driving area on the basis of the specified boundary parts 50. The operation flow progresses to step S43.

In step S43, the driving area recognition device 10 compares the provisional areas 52 determined in step S42 with the previously-recognized driving area, and judges whether a difference in area between the provisional areas 52 and the previously-recognized driving area is not less than the predetermined threshold value.

When the judgement result in step S42 indicates affirmation (“YES” in step S42), i.e. indicates that the difference in area between the provisional areas 52 and the previously-recognized driving area is not less than the predetermined threshold value, the operation flow progresses to step S13.

On the other hand, when the judgement result in step S42 indicates negation (“NO” in step S42), i.e. indicates that the difference in area between the provisional areas 52 and the previously-recognized driving area is less than the predetermined threshold value, the operation flow progresses to step S44.

In step S44, the driving area recognition device 10 determines and recognizes, as the driving area, the provisional area 52 determined in step S42.

In the second exemplary embodiment and the third exemplary embodiment previously described, the driving area recognition device 10 has the function to specify and determine the boundary parts 50. In this case, it is acceptable for the driving area recognition device 10 to have the function for recognizing the driving area on the basis of the boundary parts 50 specified by the boundary specifying section. In this modification, the driving area recognition process further has the processes in step S41 to step S44.

The driving area recognition device 10 according to the fourth exemplary embodiment has the following superior effects.

There are various cases due to the extraction state of the edge points extracted from the acquired image data, one case in which the driving area recognition device 10 can specify the boundary parts 50 can specified at both the right hand side and the left hand side, and another case in which the driving area recognition device 10 cannot specify any boundary part. According to the extraction state of the edge points 51, the driving area recognition device 10 can correctly recognize the driving area on the basis of the boundary parts 50 specified by the boundary part specifying section rather than on the basis of the number of extracted edge points 51 in each provisional area. There is also a case of reverse.

Therefore the driving area recognition device 10 can select one of the process for recognizing the driving area on the basis of the boundary parts 50 specified by the boundary part specifying section and the process for recognizing the driving area on the basis of the number of edge points 51 in each of the provisional area. This makes it possible to correctly recognize the driving area of the own vehicle on the driving lane.

In general, because the driving area recognition device 10 repeatedly recognizes the driving are every predetermined period, the currently-recognized driving area is similar in shape to the previously-recognized driving area. There is a high probability that incorrect recognition occurs due to some of these extracted edge points 51 when a difference between the previously-recognized driving area and the driving area currently recognized on the basis of the boundary parts 50 specified by the boundary part specifying section becomes not less than the predetermined threshold value (i.e. not less than the predetermined area). In order to avoid this, the driving area recognition device 10 according to the fourth exemplary embodiment recognizes the driving area on the basis of the number of extracted edge points from each provisional area. This makes it possible for the driving area recognition device 10 to correctly recognize the driving area of the own vehicle on the driving lane with high accuracy.

### Other Modifications

The concept of the driving area recognition device 10 according to the present invention is not limited by the first to fourth exemplary embodiments previously described. It is possible to provide the following modifications. The same components and functions will be designated by using the same reference numbers and characters. The explanation of the same components is omitted here.

It is acceptable for another modification of the driving area recognition device 10 to have the function of the detection result acquiring section which acquires the detection results transmitted from the detection devices for detecting various types of information regarding the driving area of the own vehicle on the driving lane. It is also acceptable for the setting section 13 in the modification of the driving area recognition device 10 to fix one or more variables, and change the values of other variables on the basis of the detection results of the detection result acquiring section.

It is acceptable for the modification of the driving area recognition device 10 to use, as the detection device, at least one detection device selected from a detection device for detecting a size (the area width L) of the driving area, a detection device for detecting a position (the offset d) of the driving area, a detection device for detecting an inclination (the yaw angle φ) of the driving area, and a detection device for detecting a shape (the curvature ρ) of the driving area.

The in-vehicle monocular camera 21 detects the size (the area width L) of the driving area. The driving area recognition device 10 receives and acquires the image data transmitted from the in-vehicle monocular camera 21, and specifies the boundary parts 50 at the right hand side and the left hand side around the own vehicle on the driving lane.

When the driving area recognition device 10 can detect and calculate a distance between the determined boundary parts 50, it is acceptable for the driving area recognition device 10 to determine and use a fixed value of the area width L of the driving area on the basis of the calculated distance, and to determine plural provisional areas 52.

When a distance between the own vehicle and the boundary parts 50 can be calculated on the basis of the acquired image data, it is acceptable for the driving area recognition device 10 to determine and use a fixed value of the offset d on the basis of the calculated distance between the own vehicle and the boundary parts 50. In this case, the in-vehicle monocular camera 21 is used as the position detection device for detecting the position (the offset d) of the driving area.

When a curvature of one of the boundary parts 50 at the right hand side and the left hand side can be detected on the basis of the acquired image data, it is acceptable for the driving area recognition device 10 to determine and use a fixed value of the detected curvature on the basis of the curvature of the boundary part 50. In this case, the in-vehicle monocular camera 21 is used as the shape detection device for detecting the shape (the curvature ρ) of the driving area.

Similarly, when an inclination between the moving direction of the own vehicle and one of the boundary parts 50 at the right hand side and the left hand side can be detected on the basis of the acquired image data, it is acceptable for the driving area recognition device 10 to determine and use a fixed value of the yaw angle φ on the basis of the detected inclination. In this case, the in-vehicle monocular camera 21 is used as the direction (the yaw rate φ) detection device for detecting the direction of the driving area.

A navigation system may be used as the detection device. It is also acceptable for the driving area recognition device 10 to uses a fixed value of each variable on the basis of various information regarding the area width L (the road width) of the driving lane, the yaw angle φ of the driving lane, and the curvature ρ of the driving lane transmitted from the navigation system.

When at least one of an area, a position, a direction and a shape of the driving area on the actual driving lane, on which the own vehicle drives, is detected, it is possible for the driving area recognition device 10 to reduce the number of variables by using the fixed value of the variable on the basis of the detection results, and to correctly recognize the driving area of the own vehicle on the driving lane with high accuracy.

In general, the area width L of the driving area is constant, it is acceptable for the driving area recognition device 10 to use the area width L which has been specified on the basis of the previously-specified boundary parts 50 arranged at the right hand side and the left hand side. This makes it possible to reduce the total number of the provisional areas 52.

It is acceptable for the driving area recognition device 10 to use a change rate of the curvature of the driving lane, a pitch angle of the driving lane as variables which affect the detection of the driving area. This makes it possible for the driving area recognition device 10 to determine and specify the provisional areas 52 which are similar to the actual driving area on the driving lane on which the own vehicle is now running.

It is acceptable for the driving area recognition device 10 according to the second exemplary embodiment to use an acceleration sensor and a vehicle speed sensor as the behavior detection devices instead of using the yaw rate sensor or in addition to the yaw rate sensor. It is acceptable for the setting section 13 in the driving area recognition device 10 to determine the range of each variable according to the behavior of the own vehicle. For example, it is acceptable for the setting section 13 to increase the range of the offset d according to increasing of a speed of the own vehicle detected by the vehicle speed sensor.

In the driving area recognition device 10 according to the first to fourth exemplary embodiments, the recognition section 15 specifies the provisional areas 52 having fewer number of the edge points 51 from the provisional areas 52 which form the area combinations having the maximum difference of the edge points, and the recognition section 15 recognizes the selected provisional area 52 as the driving area. However, the concept of the present invention is not limited by this. For example, it is acceptable for the recognition section 15 to recognize, as the driving area, the provisional area 52 having the large number of the edge points 51. It is also acceptable for the recognition section 15 to recognize an average area between the two provisional areas 52.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A driving area recognition device comprising a computer system including a central processing unit, the computer system being configured to provide:
an image acquiring section which receives and acquires image data captured by and transmitted from an in-vehicle camera;
an extraction section which extracts, from the acquired image data, edge points of boundary parts which are arranged at a right hand side and a left hand side of a driving area of an own vehicle on a driving lane on which the own vehicle drives;
a setting section which determines plural provisional areas as candidates of the driving area of the own vehicle so that at least some of the plural provisional areas are overlapped with each other,
a calculation section which calculates the number of edge points in each of the plural provisional areas; and
a recognition section which recognizes the driving area of the own vehicle on the basis of the plural provisional areas and the number of edge points in each of the plural provisional areas.

2. The driving area recognition device according to claim 1, wherein
the recognition section determines plural area combinations, each of the plural area combinations being composed of a pair of the provisional areas of the plural provisional areas so that each of the pair of the provisional areas has an overlapped area of not less than a predetermined area, the provisional areas of the pair being overlapped with each other through the overlapped area,
the calculation section calculates the number of edge points in each of the plural provisional areas for every pair of the provisional areas, and calculates a difference in the number of edge points between the provisional areas in each pair for every pair of the provisional areas, and
the recognition section determines and recognizes, the driving area of the own vehicle on the basis of a pair of the provisional areas having a maximum difference of the number of edge points.

3. The driving area recognition device according to claim 1, wherein
the setting section determines the plural provisional areas by shifting each of the plural provisional areas stepwise by a predetermined non-overlapped area,
the recognition section determines plural pairs of the provisional areas in the plural provisional areas, each of the provisional areas in each pair of the plural pairs having the predetermined non-overlapped area,
the calculation section calculates a difference in the number of edge points between the provisional areas every each pair, and
the recognition section determines and recognizes the driving area of the own vehicle on the basis of the provisional areas of the pair having a maximum difference in the number of edge points.

4. The driving area recognition device according to claim 1, wherein the calculation section adjusts the number of edge points in each of the plural provisional areas on the basis of a brightness level of each of the edge points.

5. The driving area recognition device according to claim 1, wherein the setting section determines the plural provisional areas by changing a value of at least one variable which is selected from a variable which affects an area of each of the plural provisional areas, a variable which affects a position of each of the plural provisional areas, a variable which affects an inclination of each of the plural provisional areas, and a variable which affects a shape of each of the plural provisional areas.

6. The driving area recognition device according to claim 5, wherein the recognition section detects and recognizes the driving area of the own vehicle every predetermined period, and
the setting section uses, a reference value, one or more variables which have been determined by the recognition section in a previous process of determining the driving area of the own vehicle, and the setting section determines the plural provisional areas by changing one or more variables within a predetermined range from the reference value.

7. The driving area recognition device according to claim 5, further comprising a detection result acquiring section which receives and acquires a detection result transmitted from at least one detection device which is selected from a detection device for detecting an area of the driving area of the own vehicle, a detection device for detecting a position of the driving area of the own vehicle, a detection device for detecting an inclination of the driving area, and a detection device for detecting a shape of the driving area of the own vehicle,
wherein when the detection result acquiring section acquires the detection results transmitted from at least one detection device, the setting section fixes a value of at least one of the variables on the basis of the received detection results, and changing a value of the remaining variables so as to determine the plural provisional areas.

8. The driving area recognition device according to claim 5, further comprising a behavior information acquiring section which receives and acquires behavior information regarding behavior of the own vehicle transmitted from a behavior detection device for detecting the behavior of the own vehicle,
wherein when the behavior information acquiring section acquires the behavior information regarding the behavior of the own vehicle transmitted from the behavior detection device, the setting section changes one or more variables on the basis of the acquired behavior information so as to determine the plural provisional areas.

9. The driving area recognition device according to claim 5, further comprising a boundary part specifying section which specifies the boundary parts on the basis of the edge points extracted from the acquired image data by the extraction section,
wherein the recognition section executes one of:
a recognition process for recognizing the driving area of the own vehicle on the basis of the boundary parts specified by the boundary part specifying section; and
a recognition process for recognizing the driving area of the own vehicle on the basis of the plural provisional areas and the number of edge points extracted from each of the plural provisional areas.

10. The driving area recognition device according to claim 9, wherein when the extracted edge points are not arranged in line, or when plural boundary parts are specified on the basis of the extracted edge points arranged in line, the recognition section recognizes the driving area of the own vehicle on the basis of the plural provisional areas and the number of edge points in each of the plural provisional areas.

11. The driving area recognition device according to claim 9, wherein the recognition section detects and recognizes the driving area of the own vehicle every predetermined period, and
when a difference between the driving area of the own vehicle on the basis of the boundary parts specified by the boundary part specifying section and the driving area of the own vehicle previously recognized is not less than a predetermined threshold value, the recognition section recognizes the driving area of the own vehicle on the basis of the plural provisional areas and the number of edge points extracted from each of the plural provisional areas.

12. A driving area recognition method of recognizing a driving area of an own vehicle on a driving lane on which the own vehicle drives, comprising steps of:
receiving and acquiring image data captured by and transmitted from an in-vehicle camera;
extracting, from the acquired image data, edge points in boundary parts which are arranged at a right hand side and a left hand side of the driving area of the own vehicle;
determining plural provisional areas as candidates of the driving area of the own vehicle so that at least a part of each of the plural provisional areas is overlapped with each other,
calculating the number of edge points in each of the plural provisional areas; and
recognizing the driving area of the own vehicle on the basis of the plural provisional areas and the number of edge points in each of the plural provisional areas.
